(19) United States
(12) Patent Application Publication
(10) Pub. No.: US 2026/0359111 A1
(43) Pub. Date: Nov. 12, 2026

(54) FLEXIBLE DYNAMIC AUTOSCALING ARCHITECTURE FOR DISTRIBUTED COMPUTING

(71) Applicant: Cambridge Mobile Telematics Inc., Cambridge, MA (US)

(72) Inventors: Onkar Trivedi, Somerville, MA (US); Jun-Geun Park, Lexington, MA (US); Matthew David Russo, Boston, MA (US)

(73) Assignee: Cambridge Mobile Telematics Inc., Cambridge, MA (US)

(21) Appl. No.: 19/671,627

(22) Filed: May 8, 2026

Related U.S. Application Data
(60) Provisional application No. 63/803,332, filed on May 9, 2025.

(51) Int. Cl. G06F 9/48; G06F 18/2321

(52) U.S. Cl. CPC G06F 9/4881; G06F 18/2321

(57) ABSTRACT

A system can include at least one processor and a memory storing instructions that, when executed by the at least one processor, cause the system to perform operations including receiving a configuration file including a cluster configuration and a job configuration defining a job; spawning, based on the configuration file, a cluster comprising a head node and a plurality of worker nodes; executing the job on the cluster; receiving, during the execution of the job, telemetry data associated with the cluster and the job; executing a machine learning model to analyze the telemetry data to detect an execution anomaly by correlating the telemetry data with the job configuration and historical execution metrics; performing, responsive to detection of the execution anomaly, a control action based on an output of the machine learning model, the control action modifying execution of the job; and terminating the cluster upon determining completion of the job.

### CROSS-REFERENCES TO RELATED APPLICATIONS

This application claims priority to and the benefit of U.S. Application No. 63/803,332, filed on May 9, 2025, and titled “FLEXIBLE DYNAMIC AUTOSCALING ARCHITECTURE FOR DISTRIBUTED COMPUTING WITH RAY AND EKSRAY,” the content of which is herein incorporated by reference in its entirety for all purposes.

### BACKGROUND

In large-scale data processing and machine learning tasks, managing and allocating computing resources, such as central processing units (CPUs), graphics processing units (GPUs), and memory, presents challenges. Data engineering and data science teams frequently encounter scaling limitations when utilizing conventional data processing platforms, such as Kubernetes-based orchestration tools. As data volumes grow, such platforms may face increased memory overhead, intricate cluster configurations, and escalating platform costs, particularly when scaling from small-scale testing to full production workloads. Additionally, operational visibility within these distributed environments often remains constrained. Diagnosing performance degradation typically involves navigating disparate log files, event streams, and metric dashboards, often requiring manual correlation of data points to identify performance bottlenecks or scheduling failures.

### SUMMARY

In one example, a system is provided. The system includes at least one processor; and a memory storing instructions that, when executed by the at least one processor, cause the system to perform operations. The operations include receiving a configuration file including a cluster configuration and a job configuration defining a job; spawning, based on the configuration file, a cluster comprising a head node and a plurality of worker nodes; executing the job on the cluster; receiving, during the execution of the job, telemetry data associated with the cluster and the job; executing a machine learning model to analyze the telemetry data to detect an execution anomaly by correlating the telemetry data with the job configuration and historical execution metrics; performing, responsive to detection of the execution anomaly, a control action based on an output of the machine learning model, wherein the control action modifies the execution of the job; and terminating the cluster upon determining completion of the job.

In another example, a non-transitory computer-readable medium is provided. The non-transitory computer-readable medium includes instructions that, when executed by one or more processors, cause the one or more processors to perform operations comprising: receiving a configuration file including a cluster configuration and a job configuration defining a job; spawning, based on the configuration file, a cluster comprising a head node and a plurality of worker nodes; executing the job on the cluster; receiving, during the execution of the job, telemetry data associated with the cluster and the job; executing a machine learning model to analyze the telemetry data to detect an execution anomaly by correlating the telemetry data with the job configuration and historical execution metrics; performing, responsive to detection of the execution anomaly, a control action based on an output of the machine learning model, wherein the control action modifies the execution of the job; and terminating the cluster upon determining completion of the job.

In yet another example, a computer-implemented method is provided. The computer-implemented method includes receiving, by one or more processors, a configuration file including a cluster configuration and a job configuration defining a job; spawning, by the one or more processors and based on the configuration file, a cluster comprising a head node and a plurality of worker nodes; executing the job on the cluster; receiving, by the one or more processors during the execution of the job, telemetry data associated with the cluster and the job; executing, by the one or more processors, a machine learning model to analyze the telemetry data to detect an execution anomaly by correlating the telemetry data with the job configuration and historical execution metrics; performing, by the one or more processors and responsive to detection of the execution anomaly, a control action based on an output of the machine learning model, wherein the control action modifies the execution of the job; and terminating, by the one or more processors, the cluster upon determining completion of the job.

### BRIEF DESCRIPTION OF THE DRAWINGS

Aspects and features of the various examples are described below with reference to the accompanying drawings, in which:

FIG. 1 is an example computing environment for implementing a flexible dynamic autoscaling architecture for distributed computing, according to some aspects of the present disclosure;

FIG. 2A is an example process flow utilizing the flexible dynamic autoscaling architecture for distributed computing of FIG. 1 to generate computing clusters, according to some aspects of the present disclosure;

FIG. 2B illustrates an example method for flexible dynamic autoscaling for distributed computing, according to some aspects of the present disclosure;

FIG. 2C illustrates an example method for executing a job in a distributed computing, according to some aspects of the present disclosure;

FIG. 3 is an example process flow utilizing the flexible dynamic autoscaling architecture for distributed computing of FIG. 1 to generate computing jobs, according to some aspects of the present disclosure;

FIG. 4 is an example of custom resource tagging within the flexible dynamic autoscaling architecture for distributed computing of FIG. 1, according to some aspects of the present disclosure;

FIGS. 5A and 5B are an example of task-parallelism utilizing the custom resource tags of FIG. 4, according to some aspects of the present disclosure;

FIG. 6 is an example of a flexible dynamic autoscaling architecture, according to some aspects of the present disclosure;

FIG. 7 is an example of how the EKSRay application interface of FIG. 1 can be used to integrate with other distributed data processing engines, according to some aspects of the present disclosure;

FIG. 8 is a block diagram illustrating an example computing environment for implementing a flexible dynamic autoscaling architecture for distributed computing with an operational intelligence platform, according to some aspects of the present disclosure;

FIG. 9 illustrates an example process flow of computer logic for implementing an operational intelligence platform, according to some aspects of the present disclosure;

FIG. 10 illustrates an example process flow of computer logic for implementing anomaly detection and handling, according to some aspects of the present disclosure;

FIG. 11 illustrates an example process flow of computer logic for various intervention modes of an operational intelligence platform, according to some aspects of the present disclosure;

FIG. 12 illustrates an example user interface for a job dashboard, according to some aspects of the present disclosure;

FIG. 13 illustrates an example user interface for job detail and artificial intelligence analysis, according to some aspects of the present disclosure;

FIG. 14 illustrates an example method for flexible dynamic autoscaling for distributed computing with integrated operational intelligence, according to some aspects of the present disclosure.

FIG. 15 is a block diagram of an example computing device configured to implement examples of one or more aspects of the present disclosure;

### DETAILED DESCRIPTION

The present disclosure relates generally to distributed computing. More specifically, but not by way of limitation, this disclosure relates to a flexible, dynamic autoscaling architecture for distributed computing.

Reference will now be made in detail to various and alternative illustrative examples and to the accompanying drawings. Each example is provided by way of explanation and not as a limitation. It will be apparent to those skilled in the art that modifications and variations may be made. For instance, features illustrated or described as part of one example may be used in another example to yield a still further example. Thus, it is intended that this disclosure includes modifications and variations as come within the scope of the appended claims and their equivalents.

As used herein, the terms “a,” “an,” and “the” can refer to one or more unless specifically noted otherwise. And the term “or” is not to be construed as identifying mutually exclusive options. For example, the phrase “X contains A or B” can mean that X contains A and not B, X contains B and not A, or X contains both A and B. That is, the term “or” is used to mean “and/or” unless explicitly indicated to refer to alternatives only or the alternatives are mutually exclusive.

The present disclosure relates to systems and methods for distributed computing. In large-scale data processing and machine learning tasks, efficiently managing and allocating diverse computing resources, such as CPUs, GPUs, and memory, can be complex. Conventional static allocation methods often result in computational resource underutilization or bottlenecks, which may impede performance and increase operational costs. As data volumes grow, conventional data processing platforms may face challenges including increased memory overhead, complex cluster configurations, and escalating platform costs, particularly when scaling from small-scale testing to full production workloads.

To address these and other challenges, the disclosure provides a dynamic, flexible autoscaling architecture capable of optimizing the allocation of computational resources based on workload demands. In addition to autoscaling, the disclosure describes an operational intelligence platform that integrates a continuous monitoring and diagnosis layer with an adaptive orchestration layer to facilitate control actions. This framework enables simplified job-orchestration using a unified configuration for targeted autoscaling across several processing pipeline stages.

In more detail, examples of the present disclosure incorporate a distributed computing framework designed for high-performance tasks with a highly customizable parallel container orchestration platform. An application operator may be integrated within the architecture to handle deployment and management, acting as a connector between the container orchestration platform and distributed applications. Preconfigured custom resource definitions may be provided to the application operator, enabling users to specify high-level compute requirements desired/needed for performing a particular job/task. The described computing framework can transform the specified requirements into lower-level details required to instantiate computing clusters and handle job orchestration.

In one example implementation, a computational architecture that integrates a distributed computing framework designed for high-performance tasks (e.g., Ray) with a highly customizable parallel container orchestration platform (e.g., Kubernetes, Elastic Kubernetes Service (EKS), and the like.) is provided. The techniques described herein enable a unified cluster-configuration for targeted autoscaling across several computational pipeline stages. That is, examples of the present disclosure provide a computational framework for dynamically spawning of distributed computing clusters, dynamic job orchestration within the spawned computing clusters, and automatic termination and downscaling of computing clusters depending on the processing stage of the computational pipeline. In certain examples, an end-user application interface is provided to visualize for a user a range of useful tools that abstract away (e.g., handles on the backend) complicated elements.

The computational architectures described herein can be built within a Kubernetes environment, such as Amazon EKS (hereinafter “EKS computational architecture”), or other suitable container orchestration platforms. In certain examples, EKS computational architecture can facilitate automated cluster provisioning and maintenance, can provide container scheduling, resource scaling, compute optimization, and data storage at scale for various data processing pipelines. An application operator (e.g., KubeRay operator) may be integrated within the EKS computational architecture where the application operator can handle the deployment and management of applications and acts as a connector between the EKS computational architecture and applications (e.g., Ray-based applications). Preconfigured custom resource definitions can be provided to the application operator enabling users to specify high-level compute requirements and examples of the present disclosure can transform the high-level compute requirements into lower-level details required to spin up computing clusters and handle job orchestration.

To connect the end-user to the EKS computational architecture, an application interface is provided (herein after an “EKSRay application interface”). The EKSRay application interface handles the provisioning of user-specific EKS computational architectures to spawn computing jobs (e.g., “RayJobs” and “RayClusters”), monitor clusters, visualize dashboards, launch servers or coding environments, manage cluster credentials, and interface directly with the EKS computational architecture.

To provide insights into the operational aspects of the above described computational architecture, examples of the present disclosure also provide an operational intelligence platform that integrates multiple technical layers including a continuous monitoring and diagnosis layer and an adaptive orchestration layer. The continuous monitoring and diagnosis layer can include a machine learning model that aggregates multi-source telemetry data and applies anomaly detection (e.g., rule based and AI-driven) to provide real-time, actionable root-cause analysis for operational errors and issues associated within the computational architecture. The adaptive orchestration layer can be a dynamic DAG orchestration system that enables machine learning models (such as LLMs) to adapt to computational/data conditions in real-time thereby improving throughput and resource utilization.

Numerous benefits are achieved by way of the present disclosure over conventional techniques. For example, in large-scale data science projects, a typical development pipeline might include: interfacing with database services, or data lake services, such as S3; performing extract/transform/load (ETL) processes for data assimilation and refinement; training models, such as neural networks, transformer based models, etc., with support for distributed computing at scale; running model inference and generating metrics; and handling post-processing, tracking, and publishing of computing tasks. Examples of the present disclosure enable seamless integration across all stages of the typical development pipeline to minimize friction for end users, such as data scientists.

In addition, examples of the present disclosure use existing tools integrated together in a novel manner to enable a reduction in computational resources for computational tasks, such as orchestration of machine learning pipelines, without requiring major changes to existing infrastructure. For example, examples of the present disclosure implement Kubernetes based computing environments that integrate existing computation tools, such as the KubeRay operator, that allow for specific cluster resource identification and usage (e.g. autoscaling specific types of machines, such as “r-8xlarge “instance type) directly by the KubeRay operator using resource tags thereby enabling specific autoscaling control. Examples of the present disclosure also leverage existing job orchestration mechanisms, such as Ray's gang-scheduling capabilities, to provide a stable platform that ensures computational resources exist and are available before executing pipeline stages and spawning computing clusters.

Moreover, the described operational intelligence platform provides active monitoring and dynamic remediation over workflow execution. While conventional monitoring tools, such as Grafana, Prometheus, or standard workflow engines (Airflow, Dagster), exist, such conventional tools do not perform automated, domain-specific root-cause diagnosis for distributed Ray-on-Kubernetes environments, nor do they support LLM-driven iteration of DAG topologies based on semantic execution feedback. The integration of an operational intelligence platform that serves as a “watcher” service bridges developer environments with production-grade job monitoring and enables a proactive intervention framework representing a technical advancement in the automated management of large-scale distributed computing systems.

While specific examples are provided, the disclosure is not limited to these particular configurations or distributed frameworks. The described techniques may be utilized in various environments involving large-scale data processing, model training, and real-time analytics. Industries such as autonomous vehicle development, financial services, healthcare, and telecommunications may utilize these systems to efficiently manage and scale complex computational workloads.

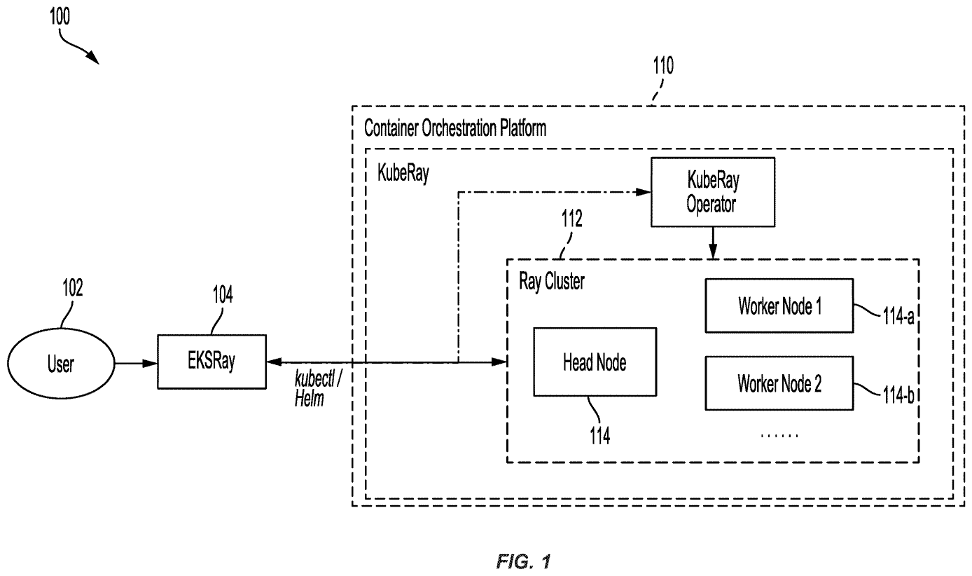

Referring now to the figures, FIG. 1 is an example computing environment 100 for implementing a flexible dynamic autoscaling architecture for distributed computing, according to some aspects of the present disclosure. As shown in FIG. 1, computing environment 100 includes a user 102, an EKSRay application interface 104 and a container orchestration platform 110. The user 102 can be one of many users interacting with the container orchestration platform 110. Requests can be received by the EKSRay application interface 104. The requests can be high-level abstractions (e.g., commands) specifying compute requirements defined by the user 102 for performing computational tasks as part of a data processing pipeline, such as a machine learning model development pipeline. In examples of the present disclosure, the EKSRay application interface 104 can provide a command line interface (CLI) acting as a wrapper for all user commands. More specifically, using a single configuration, EKSRay application interface 104 can spawn new cluster (e.g., by interpreting the configuration) by automating the process of cluster generation and then EKSRay application interface 104 can forward that cluster for the user, provide a dashboard view of the container orchestration platform 110, spawn new servers (e.g., a Jupyter server), provide secure remote access to computing devices or servers via secure shell (SSH), spawn sidecar containers, and so on.

In the machine learning context, the user 102 may want to perform tasks performed by various computational resources (e.g., CPUs, GPUs). Such tasks may include the creation of a data processing pipeline, sequence extraction, neural network pre-processing, neural network training and inference, and evaluation and metrics aggregation. Some of the tasks, such as sequence extraction and neural network pre-processing may be referred to as CPU intensive jobs while other tasks such as neural network training and inference may be referred to as GPU intensive jobs.

As mentioned above, the EKSRay application interface 104 can receive the request from user 102. The request can be a configuration file. The configuration file can be of any suitable format such as a JavaScript Object Notation (JSON) format, a YAML format, and so on.

The EKSRay application interface 104 can transform the request into lower-level commands to enable the container orchestration platform 110 to spin up a suitable pipeline based on the compute requirements defined by the user in the request. The container orchestration platform 110 can be a Kubernetes computing environment, such as an EKS environment. Within the container orchestration platform 110 can be at least one computing cluster, such as Ray Cluster 112 having head computing node 114 and various worker computing nodes 114-a, 114-b, . . . 114-n. The computing clusters of the container orchestration platform 110 can be spawned using an application operator, such as the KubeRay operator within the KubeRay computational framework as shown in FIG. 1. In addition, each computing machine of a cluster may be tagged by default whenever a new computing cluster is spawned.

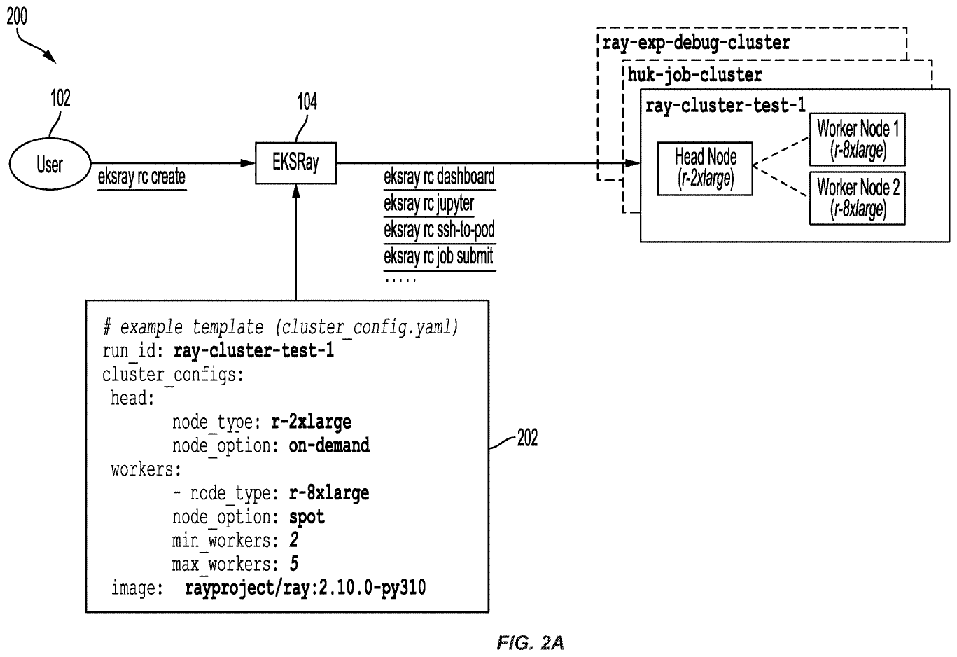

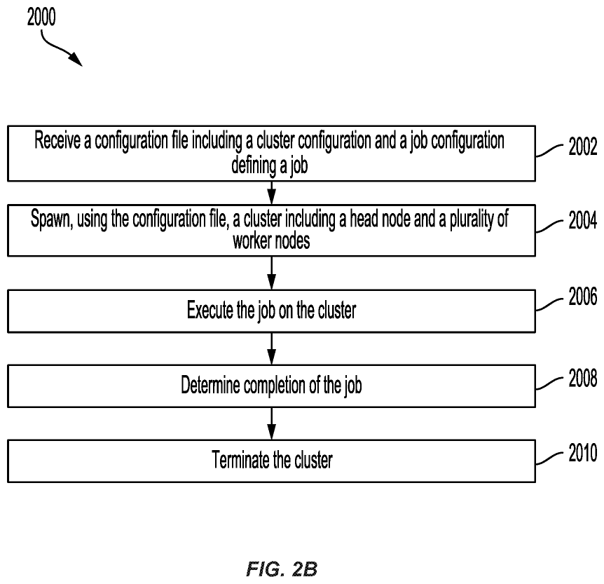

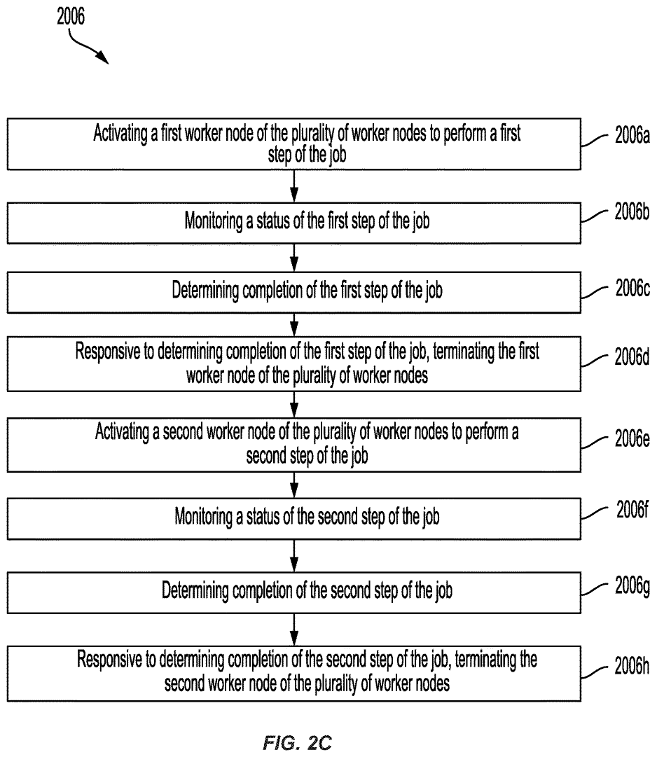

FIG. 2A is an example process flow 200 utilizing the flexible dynamic autoscaling architecture for distributed computing of FIG. 1 to generate computing clusters, according to some aspects of the present disclosure. As shown in FIG. 2A, user 102 can submit a workload request 202. The workload request 202 can be a configuration file such as a JSON file or YAML file. The workload request 202 can specify the compute requirements requested by the user 102. An example cluster_config.yaml file is shown in FIG. 2A. As shown, the workload request 202 includes a job identifier (e.g., “run_id”) and a predefined cluster configuration. More specifically, the workload request 202 includes instructions for a head computing node of type “r-2xlarge” and various worker computing nodes of type “r-8xlarge.” Responsive to receiving the workload request 202, the EKSRay application interface 104 communicates with the container orchestration platform 110 (not shown) to spawn the computing clusters as specified in the request. More specifically, the computing clusters, which may be referred to as RayClusters, is a set of machines consisting of at least one head node (e.g., a driver machine) and multiple worker computing nodes that can communicate with the KubeRay operator and a Ray auto-scaler function. The implementation of RayClusters as shown in FIG. 2A, enables a ready-to-use, cross-cluster Ray network upon spawning, the ability to autoscale worker nodes or reconfigure them dynamically (e.g., by virtue of customizable workload request 202), a containerized environment with tools for development and production, and pre-integrated connectors to the relevant databases and data lakes for bi-directional synchronization of data.

Additionally, as shown in FIG. 2A, a user need only specify a machine type (e.g., r-2xlarge) and the EKSRay application interface 104 handles allocation of appropriate resources (e.g., CPU amount, memory limits, GPU amount, etc.) and spawning of the appropriate resources for the user. For instance, EKSRay application interface 104 interprets the configuration and identifies a machine type specified in the configuration. Then, based on the machine type, EKSRay application interface 104 checks for various computational resources needed (e.g., CPU resources, memory resources, GPU resources, etc.). Based on these checks, EKSRay application interface 104 creates a second configuration that is then transmitted to the container orchestration platform 110 to appropriately spawn the clusters for the user. The second configuration can also account for global environment variables or any other configurations, such as connecting to persistent storage services. All the desired systems, variables, etc. are then wrapped into a single unified install command which is transmitted to the container orchestration platform 110 to interpret and execute. Thus, the EKSRay application interface 104 enables a user to described cluster configurations at a high level, which are then transformed, via EKSRay application interface 104, into the low level computing instructions for computing devices (e.g., the container orchestration platform 110).

FIG. 2B illustrates an example method 2000 for flexible dynamic autoscaling for distributed computing, according to some aspects of the present disclosure. In certain examples, the method 200 can be performed using one or more features or functionality described with respect to FIGS. 1 and 2A. The method 2000 will be described in the context of EKSRay application interface 104 and container orchestration platform 110; however, it may be appreciated that any suitable computing system described herein, such as computing device 1510, may be utilized to perform the method 2000. As illustrated in FIG. 2B, EKSRay application interface 104 can receive a configuration file including a cluster configuration and a job configuration defining a job (2002); spawn, using the configuration file, a cluster including a head node and a plurality of worker nodes (2004); execute the job on the cluster (2006); determine completion of the job (2008); and terminate the cluster (2010).

FIG. 2C illustrates an example method 2006 for executing a job in a distributed computing, according to some aspects of the present disclosure. The method 2006 for executing a job includes activating a first worker node of the plurality of worker nodes to perform a first step of the job (2006a); monitoring a status of the first step of the job (2006b); determining completion of the first step of the job (2006c); responsive to determining completion of the first step of the job, terminating the first worker node of the plurality of worker nodes (2006d); activating a second worker node of the plurality of worker nodes to perform a second step of the job (2006e); monitoring a status of the second step of the job (2006f); determining completion of the second step of the job (2006g); and responsive to determining completion of the second step of the job, terminating the second worker node of the plurality of worker nodes (2006h).

In some examples, the cluster configuration can include a first node type and a first node option corresponding to the head node and a second node type, a second node option, a minimum number of worker nodes, and a maximum number of worker nodes corresponding to a first worker node of the plurality of worker nodes. In some examples, the cluster configuration can further include a third node type, a third node option, a minimum number of worker nodes, and a maximum number of worker nodes corresponding to a second worker node of the plurality of worker nodes. In some examples, activating the first worker node includes defining a CPU limit, a memory limit, and a GPU limit. In some examples, the cluster configuration includes resource tags identifying at least one of the plurality of worker nodes and specifications for the at least one of the plurality of worker nodes.

In some examples, spawning, using the configuration file, the cluster can include spawning a cluster including a head node and a plurality of tagged worker nodes; executing the job by selectively activating one of the plurality of tagged worker nodes and selectively deactivating another of the plurality of tagged worker nodes; determining completion of the job; and terminating the cluster.

It should be appreciated that the specific steps illustrated in FIGS. 2B and 2C provide a particular method for flexible dynamic autoscaling for distributed computing with integrated operational intelligence according to an example of the present disclosure. Other sequences of steps may also be performed according to alternative examples. For example, alternative examples of the present disclosure may perform the steps outlined above in a different order. Moreover, the individual steps illustrated in FIGS. 2B and 2C may include multiple sub-steps that may be performed in various sequences as appropriate to the individual step. Furthermore, additional steps may be added or removed depending on the particular applications. One of ordinary skill in the art would recognize many variations, modifications, and alternatives.

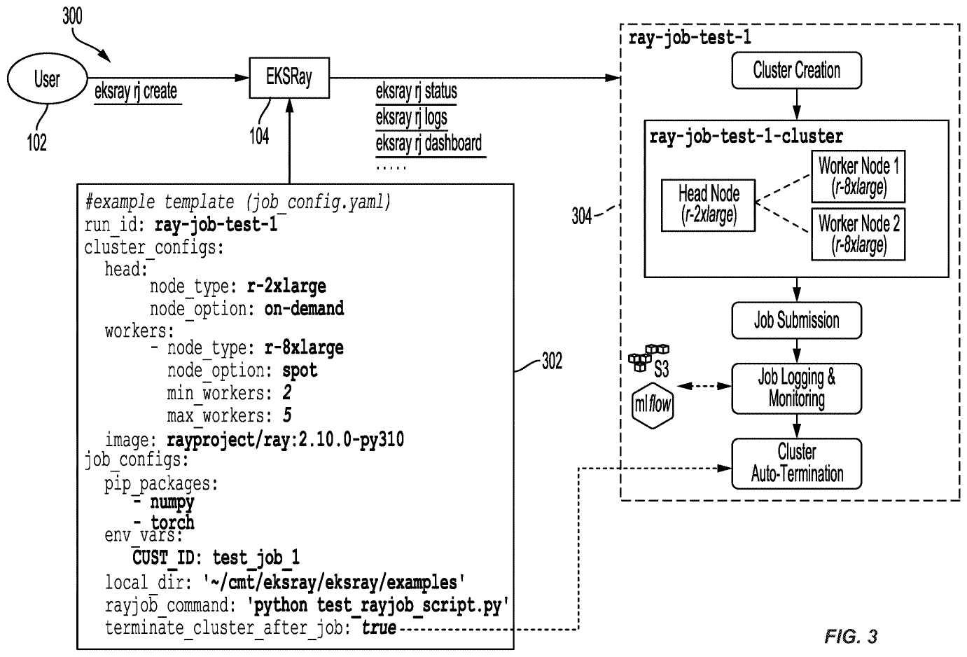

FIG. 3 is an example process flow 300 utilizing the flexible dynamic autoscaling architecture for distributed computing of FIG. 1 to generate computing jobs, according to some aspects of the present disclosure. Similar to FIG. 2A, user 102 can submit a workload request 302, which may be a configuration file such as a JSON file or YAML file, specifying the compute requirements requested by the user 102. An example job_config.yaml file is shown in FIG. 3. Similar to the cluster_config.yaml file of FIG. 2A, the job_config.yaml file shown in FIG. 3 includes instructions for a head computing node of type “r-2xlarge” and various worker computing nodes of type “r-8xlarge.” The job_config.yaml file shown in FIG. 3 also includes additional job configuration instructions. The job_config.yaml file thus enables spawning of a RayCluster, as described with respect to FIG. 2A, but also enables running a job payload as defined by the job script and environment configuration. When executed, (see e.g., ray-job-test-1 304 block in FIG. 3), the computational tasks associated with the job may be logged and monitored. In addition, and based on the job logging and monitoring, computing clusters may be auto-terminated after job completion thereby reducing computational resources associated with job execution.

As shown in FIG. 3, EKSRay application interface 104 takes in the high level details of the cluster configuration (as in FIG. 2A), but also takes in the high level details of the job that the user 102 wants to run. In some examples, the jobs can be a file or a package that the user 102 wants to run. In the workload request 302, the user 102 can specify where the file or package is located, what computing environment variables does the container orchestration platform 110 need to execute the job, what types of machine packages or system packages are required, and so on. EKSRay application interface 104 receives the workload request 302, spawns the appropriate clusters, and executes the job. In some examples, further job logging and monitoring can be performed where the results may be saved on external servers. After completion of the job, EKSRay application interface 104 supports cluster auto-termination.

The example workflow shown in FIG. 3 provides a resource-based parallelism and autoscaling. For instance, the example workflow enables a user to design a pipeline that can handle specialized tasks with custom worker-machine types which can be chained together, resulting in a flexible “per-task worker type” system that orchestrates everything through a single, coherent process. Such workflows as illustrated by FIG. 3 may be particularly well-suited for building end-to-end pipelines for model development and large-scale testing.

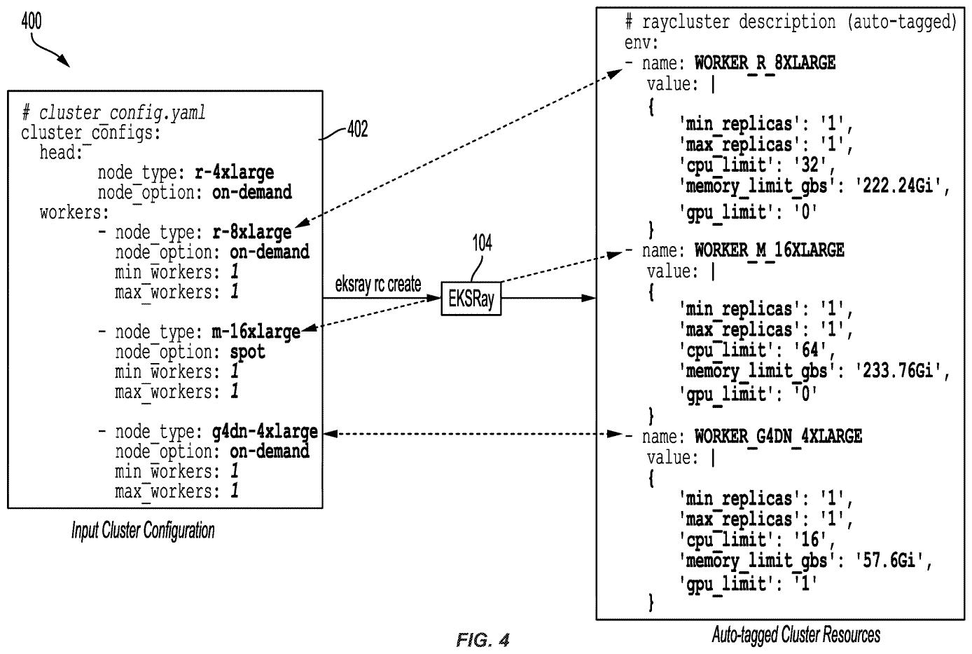

FIG. 4 is an example of custom resource tagging within the flexible dynamic autoscaling architecture for distributed computing of FIG. 1, according to some aspects of the present disclosure. More specifically, FIG. 4 illustrates a mechanism 400 of assigning specific labels to worker machines to optimize resource allocation and scheduling within the flexible dynamic autoscaling architecture for distributed computing of FIG. 1. As previously described, in the distributed computing context, examples described herein effectively manage and allocate resources to improve, e.g., optimize, performance and scalability. Examples of the present disclosure, therefore, provide mechanisms to define and utilize custom resources, enabling precise control over task scheduling, and resource-based parallelism to facilitate efficient workload execution.

FIG. 4 shows workload request 402 label cluster_config.yaml file having custom resource tags through cluster configuration. Such custom resource tags act as identifiers for each worker machine and include the machine's specifications. The custom resource tags can enable worker machine tagging that labels each worker in a RayCluster so that Ray recognizes its resource profile (e.g., CPU, GPU, memory characteristics). The custom resource tags can also enable cluster resource awareness that makes the entire RayCluster (including autoscaled resources) visible within the container orchestration platform 110, ensuring tasks are scheduled on the appropriate machines.

Staying with FIG. 4, the cluster_config.yaml file submitted by the user requests spawning of a cluster with the following components: CPU Workers: r-8xlarge; and GPU Workers: g4dn-8xlarge. For the requested cluster, the user can specify a certain “minimum” (always active) vs. “maximum” (the max no. of workers which can be provisioned after autoscaling). To specify this requirement, the cluster_config.yaml file includes the following instructions:

```
Run_id: ray-cluster-test
Cluster_resources:
  . . .
  Workers:
    - node_type: r-8xlage
    Node_option: on-demand
    Min_workers: 1 # minimum active machines
    Max_workers: 3 # max. machines with autoscaling
    - node_type: g4dn-4xlarge
    Node_option: on-demand
    Min_workers: 1
Max_workers: 3
```

Once the cluster is spawned with the above specifications, the container orchestration platform 110, as part of each worker's environment variables, can receive a full description of cluster resources, including potential-upscaled resources. This information is disseminated through the cluster as shown below:

```
name: WORKER_R_8XLARGE
  value: |
    {
      ‘min_replicas’: ‘1’
      ‘max_replicas’: ‘3’
      ‘cpu_limit’: ‘32’
      ‘memory_limit_gbs’: ‘222.24Gi
      ‘gpu_limit’: ‘0’
    }
name: WORKER_G4DN_4XLARGE
  value: |
    {
      ‘min_replicas’: ‘1’
      ‘max_replicas’: ‘3’
      ‘cpu_limit’: ‘16’
      ‘memory_limit_gbs’: ’57.6Gi
      ‘gpu_limit’: ‘1’
}
```

Here, tags such as “WORKER_R_8XLARGE” and “WORKER G4DN 4XLARGE” become visible to the RayCluster, along with the machines' specifications and autoscaling limits, thus enabling the custom resource tags to be visible within the container orchestration platform 110, ensuring tasks are scheduled on the appropriate machines.

In some examples, when a user 102 specifies a machine type (e.g., WORKER_R_8XLARGE), EKSRay application interface 104 can be configured with a predefined list of machine types that qualify for the keywords specified in the workload request. Then, based on the matched keyword of machine type in the workload request and the predefined list of machine types available in the container orchestration platform 110, the EKSRay application interface 104 can query the container orchestration platform 110 to make a determination as to whether the specified machine type is available or not. In some implementations, rather than specifying a particular machine type, user 102 can specify particular computing resources (e.g., desired CPU specifications, GPU specifications, memory specifications, etc.). In some examples, specification of particular computing resources may be of more importance than selection of a specific machine type, such as in examples where a user is performing computational tasks requiring particular hardware requirements (e.g., machine learning inference computational tasks may be require/perform better based on certain GPU specifications). As such, examples of the present disclosure enable a user to simply specify the compute requirements and then EKSRay application interface 104 can query the container orchestration platform 110 for computing resources that satisfy the user's specifications and spawn up the computing cluster accordingly.

In some examples, the predefined list of machines can further be categorized by geographic location and EKSRay application interface 104 can handle spawning of new clusters based on geographic location. In some examples, the infrastructure side of the container orchestration platform 110 can be managed with Terraform. In examples where a user 102 would like to spawn a new set of machines in a different geographic location, EKSRay application interface 104 enables the user 102 to reuse the same set of machine definitions (e.g., the same workload request) for the new set of machines spawned in a different geographic location.

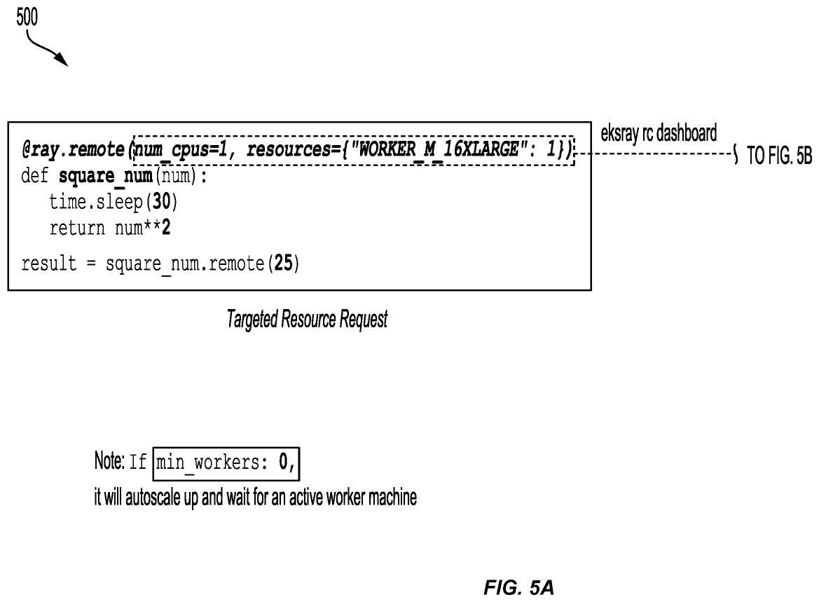

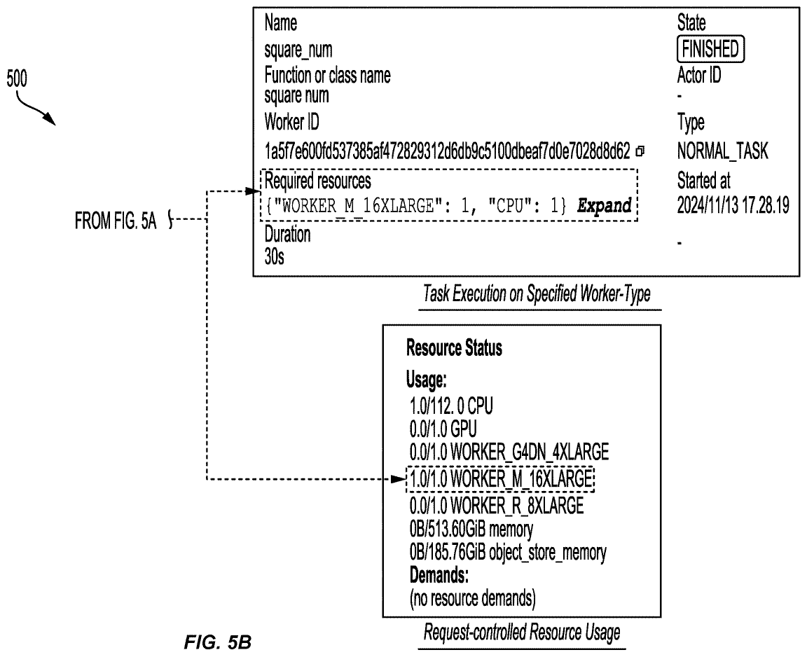

FIGS. 5A and 5B are an example of task-parallelism utilizing the custom resource tags of FIG. 4, according to some aspects of the present disclosure. More specifically, using the custom resource tags described with respect to FIG. 4, the user can directly request specific machines and resource types. As shown in FIGS. 5A and 5B, the user has requested an execution of a parallelized ray-task “square_num” using the specific machine type “WORKER_M_16XLARGE” where the specifications indicate that the cluster should only use specific CPU/GPU/memory resources from the machine-type of WORKER_M_16XLARGE to execute these tasks. This level of customization is valuable in the context where there are multiple machine types in a single cluster, including, for example, CPU-intensive tasks on large CPU nodes and GPU-specific tasks on GPU nodes. Ray and EKSRay can also spin up or down additional machines of the requested type as needed, minimizing idle costs.

In some instances, where workloads require more advance scheduling control and management, additional grouping of the computing clusters and machines can be performed. In the context of Ray, grouping compute resources of various machine-types into a single “unit” (e.g., placement group) for scheduling flexibility is possible. Additionally, examples of the present disclosure allow for scaling up or down a group of machines before or after completion of specific tasks. Moreover, examples of the present disclosure enable precise control over a number of compute bundles (CPUs, GPUs, memory) as well as real-time tracking and management of placement groups.

According to one particular example, and staying with the RayCluster example introduced above, cluster-specifications from any machine or location within the RayCluster can be extracted using the following pseudocode commands:

Python
Import os
Worker_r_8xlarge_env =
os.environ.get(“WORKER_R_8XLARGE”)
Worker_m_16xlarge_env =
os.environ.get(“WORKER_M_16XLARGE”)

The above pseudocode commands access environment variables to obtain detailed specifications of worker nodes in the RayCluster. By retrieving configurations such as WORKER_R_8XLARGE and WORKER_M_16XLARGE, the resource capacities (e.g., CPU, memory) of each worker type are extracted. Once, the resource capacities of each worker type are extracted, placement group bundles may be generated from the following pseudocode commands:

```
Python
From ray.util.scheduling_strategies PlacementGroup SchedulingStrategy
Worker_r_8xlarge_spec = {
  “cpu” : worker_r_large_env[‘cpu_limit’], no. cpus for a worker
  “memory”: worker_r_8xlarge_env[‘memory_gbs’] * 1024 *1024 *1024, # memory
in bytes for a worker
  “WORKER_R_8XLARGE: 1
} * worker_r_8xlarge_env[ ‘num_available_workers’]
# here, it defaults to 1 for our case for simplicity
Worker_m_16xlarge_spec = {
# Similarly define specs for your second worker type
} * worker_m_16xlarge_env[‘num_available_workers’]
Final_task_group = [worker_r_8xlarge_spec, worker_m_16xlarge_spec]
```

As shown above, the pseudocode commands construct resource bundles that define the allocation of resources for tasks within the cluster. Utilizing the PlacementGroupSchedulingStrategy from Ray, the pseudocode commands specify the number of CPUs, memory, and custom resources required for each worker type. Creation of these bundles, ensures that tasks are scheduled on computing nodes with appropriate resources, optimizing performance and resource utilization. Next, utilizing the generated placement group bundles, the placement groups may be spawned on demand from the following pseudocode commands:

```
Python
# define the placement group
Task_placement_group = ray(
  Final_task_group
  Strategy=’SPEAD’,
)
# Initialize the placement group
Pg_strategy = PlacementGroupSchedulingStrategy(
  Placement_group=task_placement_group
)
#WAIT for group machines to become active
Ray.get(task_placement_group.ready( ), timeout=timeout_min*60)
```

This segment of the pseudocode commands initializes a placement group using the previously defined resource bundles. The placement_group function in Ray creates the group with a specified strategy, such as “SPREAD”, which distributes tasks evenly across available nodes to balance the load.

In some implementations, the above described techniques related to placement groups and spawning of placement groups may be abstracted into helper-functions which are available via existing repositories utilizing the EKSRay application interface 104 (e.g., a number of parameters with this approach can be controlled such as fine-grained resource utilization for a cluster, configurable parallelism via bundling and scheduling strategies, and explicit control over when and how these resources are allocated or deallocated).

In one implementation, an extension of the above described placement groups includes the ability to “gang-schedule” tasks. Gang scheduling ensures that a set of tasks or actors only starts when all the required resources are available at the same time. If those resources cannot be allocated together, none of the tasks in the group execute. Gang-scheduling is especially important for applications requiring coordinated execution across multiple parallel workers, such as ETL processes that require synchronized parallel operations, or distributed training and tuning with Ray Train and Ray Tune.

In one particular example, consider the following set of worker-machines and bundles defined by the following pseudocode:

```
Python
Final_task_group_bundled _ [
  {“CPU”: 1, “WORKER_R_8XLARGE”:
  0.01}. # Bundle using 1 CPU from the r-8xlarge
{“CPU”: 1, “m_16xlarge”: 0.01}.
# Bundle using 1 CPU from the m-16xlarge
```

The above pseudo codes creates a group with two bundles, each using a single CPU from the r-8xlarge and the m-16xlarge workers in the cluster. The custom resource tags, such as ““WORKER_M_16XLARGE”: 0.01,” indicate that the resource can be re-used again in subsequent bundles (i.e. in this example, a single “bundle” is not using up all the resources of that worker machine). Based on the above bundles, the following pseudocode commands illustrate an example of gang-scheduling of a simple Ray-task:

```
Python
import ray
from ray.util.placement_group import placement_group,
PlacementGroupSchedulingStrategy
# create the task group, pg strategy
final_task_group_bundled = [
  {“CPU”: 1, “WORKER_R_8XLARGE”: 0.01}, # Bundle 1: 1 CPU from r-8xlarge
  {“CPU”: 1, “WORKER_M_16XLARGE”: 0.01}, # Bundle 2: 1 CPU from m-16xlarge
]
task_placement_group = placement_group(
  final_task_group_bundled,
  strategy=“SPREAD” # ensures tasks are spread across nodes
)
pg_strategy = PlacementGroupSchedulingStrategy(
  placement_group=task_placement_group
)
# wait for the placement group to become ready (timeout 10 mins)
ray.get(task_placement_group.ready( ), timeout=10 * 60)
print(“Placement group is ready!”)
# define a simple task that will utilize the bundles
@ray.remote
def task(name):
  import time
  time.sleep(2) # simulate some work
  return f“Task {name} completed on worker!”
# schedule tasks using the specific bundles
task_1 = task.options(
  scheduling_strategy=pg_strategy,
  bundle_index=0
  ).remote(“Task 1 (r-8xlarge)”)
task_2 = task.options(
  scheduling_strategy=pg_strategy,
  bundle_index=1
).remote(“Task 2 (m-16xlarge)”)
# wait for the tasks to complete
Results=ray.get([task_1, task_2])
# continue with the rest of the code once the above tasks are complete.
```

At a high level, the above pseudocode breaks down into the following steps: form a placement group with explicitly defined resource bundles (two bundles, each using one CPU from a different worker type); wait for the bundles to be ready, which also handles any autoscaling needed; specify per-bundle tasks by setting bundle_index to tie each task to a particular worker type (e.g., r-8xlarge or m-16xlarge); and gang-scheduled execution means these tasks do not start until all required resources (across both bundles) are available simultaneously, ensuring coordinated and consistent performance.

The above approach provides numerous benefits, particularly in scenarios where certain resources are limited or expensive, such as high-end GPU nodes. That is, the above approach ensures a task does not begin without guaranteeing the availability of all necessary computational resources thereby avoiding partial allocations and potential bottlenecks.

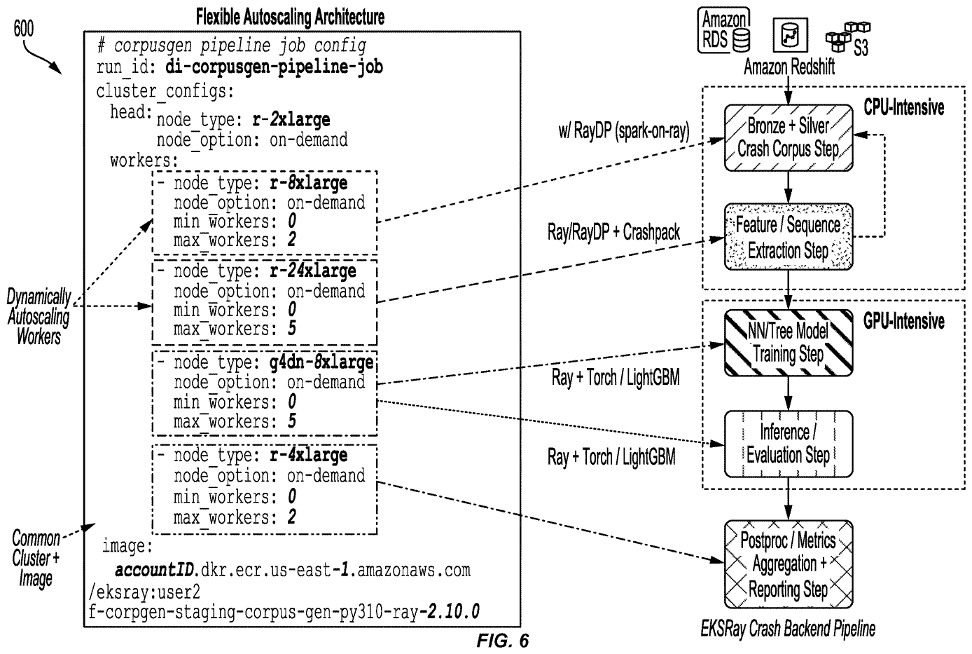

FIG. 6 is an example of a flexible dynamic autoscaling architecture, according to some aspects of the present disclosure. Examples of the present disclosure combine the techniques described above with respect to FIGS. 1-5 into one unified configuration for executing large-scale pipelines without requiring multiple separate clusters or extensive manual oversight of resource allocation. FIG. 6 and the below description provides an example as to this consolidation may be performed.

First, a single RayCluster is spawned including a single head node (serving as the driver machine) and multiple worker types with different resource profiles. This unified approach ensures that all tasks within the pipeline can be performed in the same environment, removing the need for duplicated cluster setups or additional overhead. Multiple worker node types are specified in the cluster configuration. For instance, r-8xlarge for CPU-intensive tasks, g4dn-8xlarge for GPU-centric steps, and possibly others like m-16xlarge for memory-intensive operations). By setting min_workers=0 for certain worker types, those machines only spin up when tasks actually require them, thereby keeping costs minimized when the resources are idle.

Then, to address tasks that require coordinated or simultaneous resource allocation, for instance, distributed training across multiple nodes, or large-scale ETL operations that need parallel execution, EKSRay application interface 104 supports Ray's placement groups (PGs) and gang scheduling. Such features ensure that a group of tasks can be delayed until all of the requested resources are allocated together, guaranteeing consistency and avoiding partial or staggered execution starts. Chaining all the pipeline stages together into a single RayJob (e.g., see modeling pipeline on right portion of FIG. 6) results in unified job logging and monitoring (e.g., all task steps and logs are consolidated in one place, simplifying debugging and performance analysis); seamless autoscaling across stages (e.g., the system automatically provisions and deprovisions the exact resources each step needs, helping optimize both performance and cost); and easier prototyping-to-production transition (e.g., most pipeline code remains unchanged when scaling from small datasets to very large ones, only the cluster configuration might need updates to accommodate increased resource demands).

Staying with FIG. 6, the modeling pipeline (see modeling pipeline on right portion of FIG. 6) encompasses multiple stages including: metadata querying and processing; corpus generation; feature extraction; model training; model inference; post-processing, and metrics reporting, where each stage exhibits different resource profiles. For instance, the resource profile of each stage may be described as follows: metadata querying/corpus generation having lighter compute requirements and often more I/O bound, possibly dependent on AWS services like RDS, Redshift, or S3; feature extraction with highly parallelizable compute requirements/capabilities, benefiting from scaling up CPU workers to handle large-scale data and integration of RayDP (Spark-on-Ray) to enhance performance by leveraging Spark's robust data processing capabilities within the Ray ecosystem and for cross-platform compatibility; model training & inference where compute requirements are generally GPU-intensive, especially in the context of advanced deep learning frameworks (although in some examples this processing stage can comprise hybrid compute requirements (CPU+GPU)); and post-processing and reporting where compute requirements are typically CPU-focused (although in some examples this processing stage can require memory-intensive steps depending on the size of generated outputs).

With a hybrid cluster that includes CPU-focused and GPU-equipped worker nodes and a single head node orchestrating tasks, the EKSRay application interface 104 can dynamically spin up and scale only the portions of the cluster needed for each stage. Once each task is completed, the auto-scaler spins resources back down, keeping costs (both monetary and computational costs) low.

Examples of the present disclosure also provide a robust computational architecture for future implementations because of their integration of existing computational tools thereby providing high adaptability to ongoing developments. More specifically, the EKSRay application interface 104 enables the creation of a unified cluster configuration that accommodates diverse resource requirements, from CPU-intensive ETL tasks to memory-intensive data transformations and GPU-enabled model training and inference. This configuration allows users to precisely tailor resource allocation, minimize idle times between pipeline stages, and maximize cluster compute efficiency. The EKSRay interface platform further streamlines this process by reducing the traditional overhead associated with scaling and cluster management, allowing data scientists to focus more on innovation and less on infrastructure challenges.

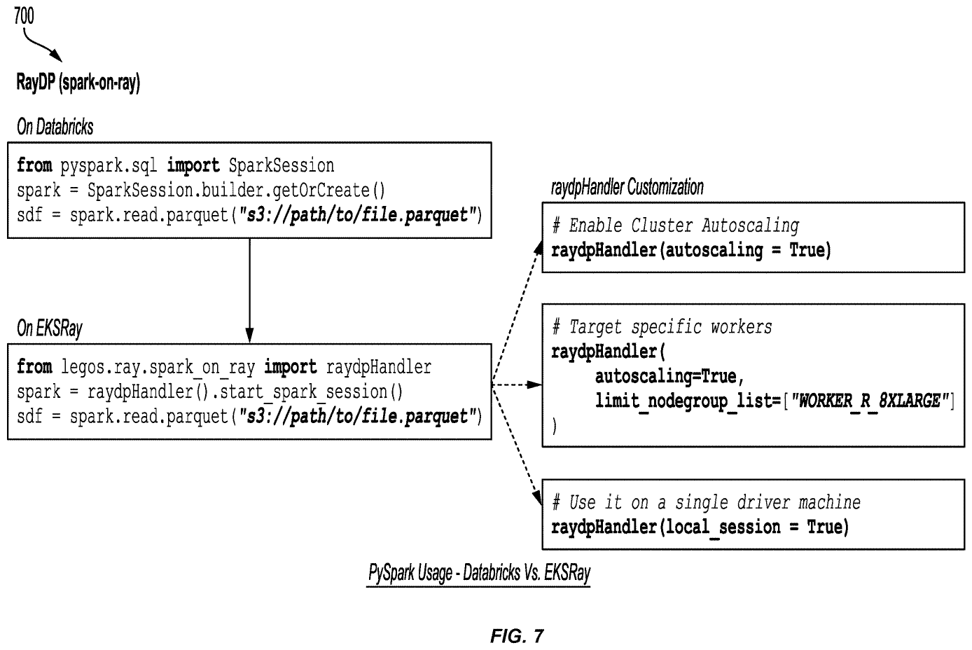

FIG. 7 is an example of how the EKSRay application interface of FIG. 1 can be used to integrate with other distributed data processing engines. For example, assume a first distributed data processing engine runs using JavaScript on the backend having a different cluster types (e.g., Spark clusters). Further, assume a user of the first distributed data processing engine wants to switch to the container orchestration platform 110, which uses Ray on the backend. Examples shown in FIG. 7 allow the user to use the existing work (e.g., the Spark clusters) within the container orchestration platform 110. As shown in FIG. 7, a wrapper is provided to the EKSRay application interface 104 to enable communication between the container orchestration platform 110 other distributed data processing engines. That is, integrating RayDP into the EKSRay application interface 104 enables a user to run distributed data processing engines such as Spark on top of Ray. In some examples, the integration of Spark on top of Ray via the EKSRay application interface 104 enables a user to write PySpark code together with other Ray libraries in the same python program thereby improving productivity and expressivity.

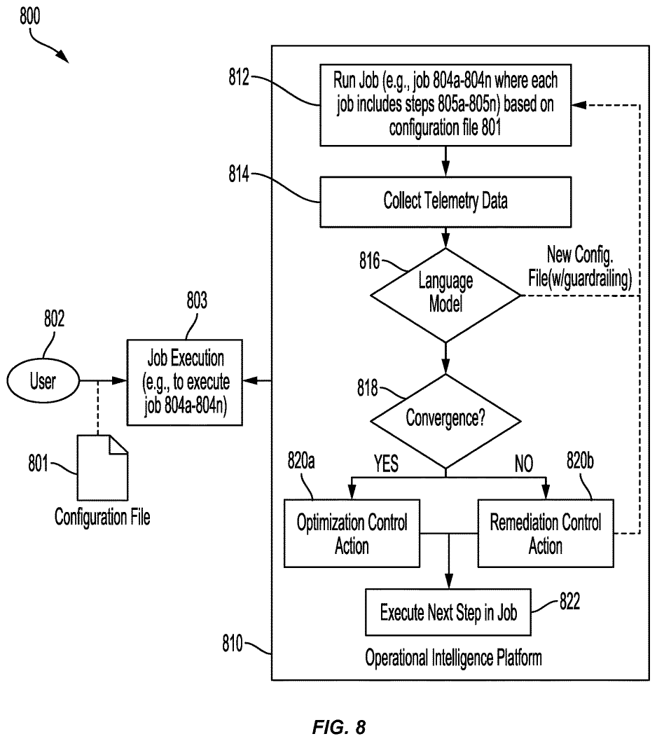

FIG. 8 is a block diagram illustrating an example computing environment 800 for implementing a flexible dynamic autoscaling architecture for distributed computing with an operational intelligence platform, according to some aspects of the present disclosure. A user 802 can interface computing environment 800 to effectuate a job execution 803. As described with respect to FIGS. 1-7, user 802 may provide a configuration file 801 that defines high-level compute requirements, such as machine specifications or resource profiles for effectuating job execution 803 to execute job 804a-804n (e.g., jobs can include model training, data processing optimization, architecture-search optimization, etc.).

Configuration file 801 is processed by job execution 803 to cause worker node generation, spawn clustering, and perform related computational tasks. In addition to the autoscaling operations described previously, the computing environment 800 may incorporate an operational intelligence platform 810 to provide real-time diagnostic visibility. Operational intelligence platform 810 can monitor the telemetry data generated during job execution 803 to provide intelligent insights regarding the operational health and performance of jobs 804a-804n. In some examples, a single user, such as user 802, may initiate one or more jobs 804a-804n.

Operational intelligence platform 810 can be integrated into computing environment 800 to provide automated monitoring and management of job execution 803. Operational intelligence platform 810 can monitor computing environment 800, collecting telemetry data associated with job execution 803, to provide intelligent insights to user 802 and facilitate control actions. In some examples, operational intelligence platform 810 can operate as a persistent service, performing continuous or periodic polling over job execution 803 to monitor and track operational health and resource utilization within computing environment 800.

Included within operational intelligence platform 810 is an example computer logic flow for monitoring and tracking performed by operational intelligence platform 810 over job execution 803. During execution, the computer logic flow begins at step 812 where a job is executed by job execution 803. A single job (e.g., job 804a) can include one or more steps 805a-805n. During job execution, operational intelligence platform 810 performs step 814 to collect telemetry data from the container orchestration platform associated with job execution 803. As described herein, telemetry data may include resource utilization metrics, log data, and system events. Operational intelligence platform 810 can transmit this data to a language model 816 to analyze the current state of a particular step of job execution 803.

Language model 816 can be a machine learning model trained on a corpus of telemetry data including historic telemetry data of previous job executions with associated ground truth labels. Language model 816 can evaluate the telemetry data at step 818 to determine if job execution 803 has reached convergence. Convergence as described herein refers to the ability of job execution 803 to achieve an objective set forth in the job. If convergence is achieved, then the computer logic flows to optimization control action 820a. Optimization control action 820a can involve logging the parameters of configuration file 801 such that similar or the same parameters may be recommended for subsequent jobs. In this way, optimization control action 820a can provide transferable insight regarding job execution 803, which may be indexed for subsequent similar jobs.

When convergence is not achieved, language model 816 has predicted an error or issue (e.g., an anomaly) associated with job execution 803 and the computer logic can flow to remediation control action 820b. In some examples, the anomaly can be associated with an individual step of an individual job. In some examples, the anomaly can be a global issue identified with job execution 803 (e.g., the job is consuming more computing resources than expected or taking longer to process than expected). Example anomalies can include memory exhaustion events, CPU or GPU utilization stalls, job progress stagnation, or task scheduling failures. In some examples, remediation control action 820b can include generation, via language model 816, of a new configuration file which can be a modified version of configuration file 801. The modification can be a predicted change to configuration file 801 to remediate the identified error or issue. Other example remediation control actions can include automatically terminating a stalled job to release resources, resubmitting the job with an adjusted parameter set (e.g., increased memory allocation or adjusted parallelism), or issuing a preemptive notification to user 802 via a message. Finally, at step 822, the operational intelligence platform 810 can execute the next step in the job, continuing the automated loop until the job execution 803 terminates.

In certain examples, the operational intelligence platform 810 provides a technical improvement to the functioning of distributed computing environments by automating the detection and remediation of operational anomalies. The operational intelligence platform 810 employs a trained machine learning model to analyze telemetry data to detect execution anomalies, such as memory exhaustion or resource utilization stalls, by correlating incoming data with historical execution metrics. Upon detection, operational intelligence platform 810 determines that the detected anomaly is associated with a specific operational issue (e.g., task stagnation or scheduling failure) and identifies the root cause in real time. Responsively, the operational intelligence platform 810 performs a control action to remediate the anomaly, such as automatically modifying a job configuration or terminating and resubmitting a stalled process, without requiring intervention from a human operator. By proactively remediating operational issues in real time based on the machine learning model's output, the platform improves the reliability and resource efficiency of the distributed computing environment, providing a specific computer-implemented solution to the technical problem of maintaining system stability in large-scale data processing pipelines.

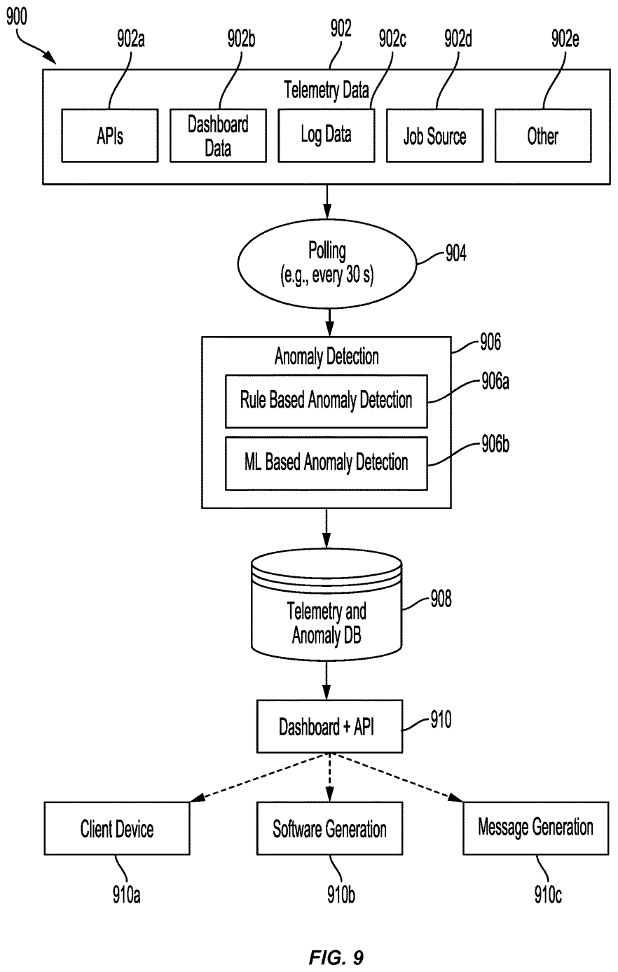

As illustrated in FIG. 8, operational intelligence platform 810 includes language model 816. Examples described with respect to FIGS. 9-11 may similarly employ one or more machine learning models, such as language model 816, to facilitate one or more aspects of the present disclosure. The machine learning models described herein, including language model 816, may be implemented as a deep learning architecture, such as a neural network (e.g., a transformer-based sequence model or a recurrent neural network), specifically engineered for high-throughput processing of time-series telemetry data. Example architectures can include an input layer configured to receive normalized telemetry feature vectors, which encode multi-dimensional operational metrics including, but not limited to, CPU and GPU saturation rates, memory paging frequencies, network I/O latency, and thread contention levels. These high-dimensional inputs are passed through a series of hidden layers, such as gated recurrent units (GRUs) or multi-head attention layers, that extract spatial-temporal dependencies from the telemetry stream. The example architectures usable herein may be optimized to project these features into a latent representation of overall system health, which may then be processed by a final output layer (e.g., a softmax layer) to generate control action vectors, such as probability distributions for specific autoscaling actions or remediation trigger signals.

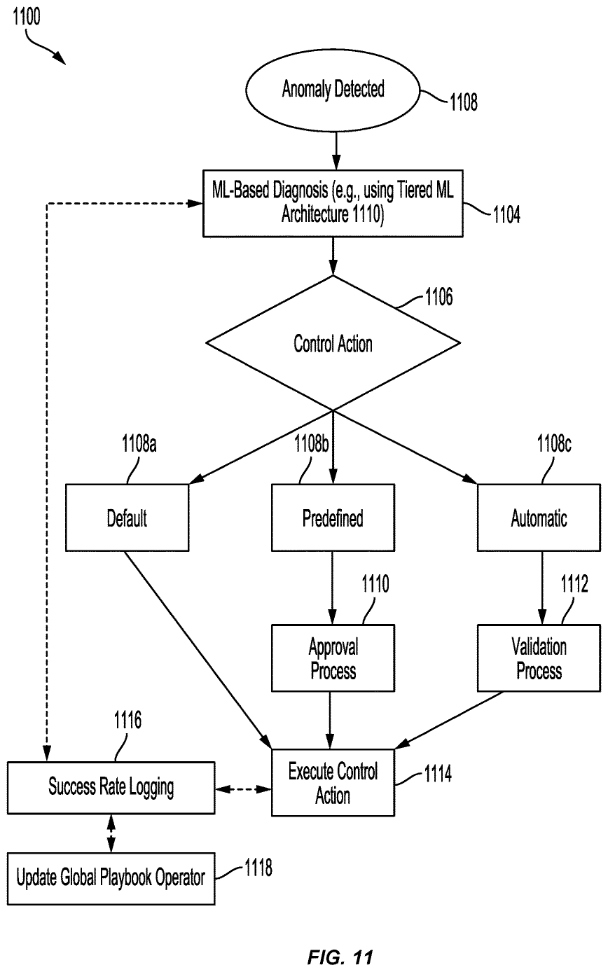

In one example, a training process for a machine learning model usable to perform one or more aspects of the present disclosure, such as language model 816, involves supervised learning utilizing historical telemetry and event log datasets, which can be pre-processed through discretization and normalization to minimize computational variance. During the training phase, an optimization algorithm, such as stochastic gradient descent (SGD), may be used to minimize a multi-objective loss function. In this context, a multi-objective loss function can be mathematically configured to penalize both false positives in anomaly detection and latency in remediation response, thereby specifically tuning the machine learning model parameters to balance system stability with computational overhead. Furthermore, example machine learning architectures described herein may support continuous learning, where machine learning models periodically incorporate real-time feedback (e.g., as derived from the success rate logging 1116 described with respect to FIG. 11). This dynamic, closed-loop training process allows machine learning model refinement over internal weightings based on the observed causal impact of prior remediation actions on cluster performance, ensuring that the model mathematically adapts to the specific, evolving resource demands of the distributed computing environment.

In one example, job execution 803 may involve a training job where the training job is associated with training a machine learning model. In the vehicle telematics context, the machine learning model undergoing training facilitated by job execution 803 may be trained to analyze vehicle telematics data to detect vehicle crashes or driving behaviors (acceleration, hard braking, risky driving, etc.). In these scenarios, the convergence determination at step 818 may be based on a target performance analysis (e.g., whether a custom model has achieved a threshold level of predictive accuracy). This allows the operational intelligence platform 810 to serve as a completely automated framework that manages the iterative training of highly specialized models by dynamically adjusting configurations and parameters based on intermediate execution results until an optimized custom model is produced.

FIG. 9 illustrates an example process flow of computer logic 900 for implementing an operational intelligence platform, according to some aspects of the present disclosure. Computer logic 900 shares similar features as the computer logic described in FIG. 8 with respect to operational intelligence platform 810, and thus the same reference numerals designate similar components or functionality. In some examples, computer logic 900 may supplement or replace the computer logic described with respect to FIG. 8 to provide enhanced observability and automated monitoring.

FIG. 9 includes telemetry data 902, which may be aggregated from a plurality of sources including dashboard APIs 902a, dashboard data 902b, log data 902c, job source 902d, and other data 902e. Dashboard APIs 902a may provide programmatic access to the container orchestration platform for retrieving job statuses, deployment states, and resource definitions. Dashboard data 902b may encompass performance metrics, such as processor utilization, memory usage, and GPU activity tracked on a per-node basis. Log data 902c may include diagnostic messages, standard output, and error streams parsed during job execution 803 to track progress or identify failure signatures. Job source 902d may encompass the driver scripts, configuration files, and runtime environment definitions utilized to instantiate the computational tasks. Other data 902e may include machine learning experiment parameters, performance metric histories, and cluster events, such as node scheduling failures or resource-related termination events, that contextualize job execution 803.

Telemetry data 902 may be polled on a continuous or periodic basis. In certain examples, polling 904 may execute a poll loop at a predetermined interval, such as every 30 seconds, to collect snapshots of job execution 803. Polling 904 can also include auto-discovering active computational jobs by observing service definition resources within the container orchestration platform. In this way, polling 904 may be executed in an automated manner. Upon discovery of active telemetry data, telemetry data 902 may be aggregated for a particular job from the plurality of data sources, such as by querying application interface endpoints for resource metrics or parsing execution logs to determine job progress. The aggregated data may then be processed by anomaly detection components 906.

Anomaly detection 906 may include rule-based anomaly detection 906a, which can evaluate telemetry data against predefined threshold criteria to identify execution anomalies. These rules may be configured to trigger when specific metrics deviate from safe operational limits, such as when memory usage exhibits a sustained upward trajectory, when processor or GPU utilization falls below a specific percentage despite active job progress, or when job progress remains stagnant for a duration exceeding a predetermined limit. Rule-based anomaly detection 906a provides a deterministic approach to anomaly identification that can operate with reduced computational overhead.

Anomaly detection 906 may further include machine learning based anomaly detection 906b, which can employ probabilistic or pattern-recognition models to identify execution anomalies that are not captured by deterministic rules. Machine learning based anomaly detection 906b may be trained on historical telemetry data to establish baseline performance profiles for specific job types or resource configurations. Upon observing telemetry data that deviates from these established baselines, the model may flag potential anomalies that indicate subtle performance degradation or emerging resource contention. By combining rule-based and machine learning approaches, the platform can effectively identify a wide range of operational issues while maintaining sensitivity to job-specific behaviors.

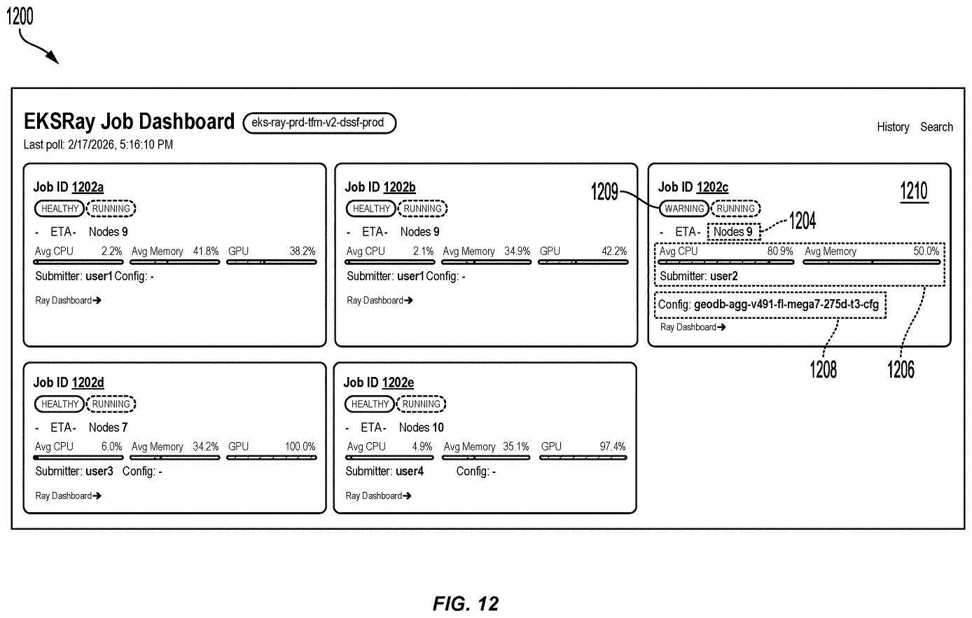

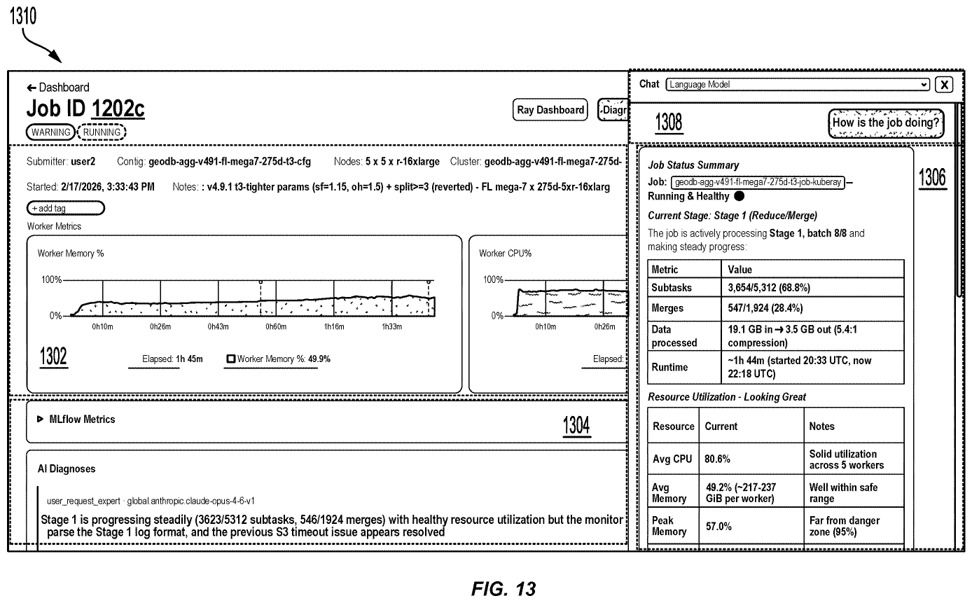

Identified anomalies and associated telemetry data 902 may be stored in telemetry and anomaly database 908 for real-time display via dashboard and API 910 or for post-job execution analysis. In some implementations, database 908 may utilize a two-tier storage architecture, such as a local relational database for indexed job metadata and a cloud-based storage system for long-term archival of logs and historical telemetry snapshots. Dashboard and API 910 can include various features and functionality, which are described in greater detail with respect to FIGS. 12-13. As shown in FIG. 9, dashboard and API 910 includes display signals for client device 910a, software generation 910b, and message generation 910c. Client device 910a can provide a web-based interface for visualizing job status, resource utilization, and diagnostic timelines. Software generation 910b can facilitate the automatic generation of remediation code or modified configuration files, which can be presented for operator review. Message generation 910c can format and deliver automated notifications, such as status alerts or diagnostic summaries, to external communication platforms to facilitate proactive operator engagement.

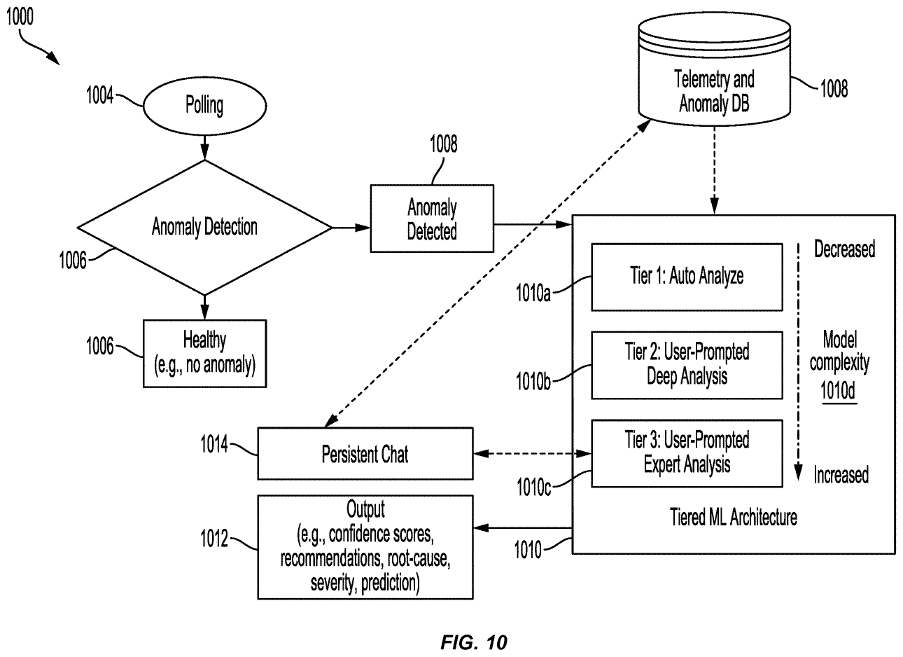

FIG. 10 illustrates an example process flow of computer logic 1000 for implementing anomaly detection and handling, according to some aspects of the present disclosure. Computer logic 1000 shares similar features as the computer logic 900 described in FIG. 9, and thus the same reference numerals designate similar components or functionality. For example, computer logic 1000 includes polling 904, anomaly detection 906, and telemetry and anomaly DB 908. In some examples, the computer logic 1000 may supplement or replace the computer logic 900 described with respect to FIG. 9 or the computer logic described with respect to FIG. 8 to provide enhanced observability and automated monitoring. For instance, if anomaly detection 906 determines job execution is healthy (e.g., no anomaly) 1006, then computer logic 1000 may flow to an optimization control action, such as optimization control action 820a described with respect to FIG. 8. If anomaly detection 906 analyzes a job execution and determines an anomaly detected 1008, then computer logic 1000 can flow to tiered ML architecture 1010 for anomaly handling.

As illustrated in FIG. 10, tiered ML architecture 1010 includes multiple tiers of anomaly handling models with increasing model complexity 1010d. Tier 1: Auto-Analyze 1010a involves an automated diagnostic routine that may be triggered immediately upon the detection of an anomaly 1008 by the rule-based system. This tier may utilize a high-throughput, low-latency machine learning model to generate an initial structural diagnosis without requiring direct user interaction. Tier 2: User-Prompted Deep Analysis 1010b involves an interactive diagnostic process that may be invoked upon a user's request, such as when the user requires a more granular explanation of the detected anomaly. This tier may employ a machine learning model capable of handling more complex reasoning, integrating additional context from telemetry and anomaly DB 908 to provide a detailed breakdown of identified performance degradation. Tier 3: User-Prompted Expert Analysis 1010c involves an intensive, expert-level diagnostic process that may be initiated by the user for ambiguous or persistent issues that remain unresolved by Tiers 1 and 2. This tier may utilize a machine learning model with the highest available reasoning capabilities and may support multi-turn persistent chat 1014, allowing the model to leverage tool-use capabilities, such as querying log files or browsing documentation, to isolate a root cause. The platform may generate output 1012, which can comprise diagnostic information including confidence scores, root-cause identification, severity levels, and prioritized remediation recommendation.

In certain examples described herein, the automated generation and execution of remediation actions or optimized configurations can be governed by a guardrail framework. Such a framework can be applied to the various computer logic examples described herein to constrain autonomous operations within predefined safety parameters. For example, the guardrail framework may enforce limits such as a maximum retry count for failed operations, a cooldown period between successive actions to prevent system instability, and a cost ceiling to limit total computational expenditure. Furthermore, the guardrail framework may be configured to enforce “blast radius constraints,” which can limit the scope of autonomous modifications to specific parameters, such as memory allocation or parallelism settings, thereby preventing unintended infrastructure changes. Additionally, the techniques described herein can support graduated intervention modes, ranging from passive suggestion to approval-gated execution, and finally to autonomous operation for well-characterized failure patterns. By maintaining an audit trail of diagnoses, guardrail states, and outcomes (e.g., in telemetry and anomaly DB 908), the system can provide full traceability for post-incident review, ensuring that automated outputs remain within reliable and predictable operational bounds. Additional details regarding guardrail implementations are described with respect to FIG. 11, below.

FIG. 11 illustrates an example process flow of computer logic 1100 for various intervention modes of an operational intelligence platform, according to some aspects of the present disclosure. Computer logic 1100 shares similar features as the computer logic described with respect to FIGS. 8-10, and thus the same reference numerals designate similar components or functionality. For example, computer logic 1100 includes anomaly detected 1108 and ML-Based diagnosis 1104 (e.g., using tiered ML architecture 1010). In some examples, the computer logic 1100 may supplement or replace the computer logic 1000 described with respect to FIG. 10, the computer logic 900 described with respect to FIG. 9, or the computer logic described with respect to FIG. 8 to provide enhanced observability and automated monitoring.

Computer logic 1100 illustrates various intervention modes of control action 1106 including default 1108a, predefined 1108b, and automatic 1108c. The control action 1106 may include signaling output by the ML-based diagnosis 1104 to select a proper intervention model for the anomaly detected 1108. Default 1108a, also referred to as a passive notification or suggestion mode, represents a lower-risk intervention level. In this mode, the ML-based diagnosis 1104 generates and displays actionable recommendations to the user, for example, via a web interface, a messaging platform, or an integrated developer environment tool. This represents the baseline behavior, where the ML-based diagnosis 1104 provides diagnostic information and potential remediation paths, while the human operator retains decision-making authority to determine whether and how to proceed.

Predefined 1108b, also referred to as an approval-gated or prepared action mode, represents a medium-risk intervention level. In this mode, the ML-based diagnosis 1104 prepares a concrete, executable action, such as a modified configuration file or a command to terminate and resubmit a job, and presents the prepared action to the user for explicit confirmation via the approval process 1110. This mode bridges the gap between passive recommendation and full automation, ensuring that significant system modifications, such as changing memory allocations or parallelism settings, are validated by a human operator before being effectuated.

Automatic 1108c, also referred to as an autonomous or guard railed execution mode, represents a bounded-risk intervention level reserved for well-understood failure patterns with predictable remediation outcomes. This mode involves the validation process 1112, where the proposed action is automatically verified against strict safety guardrails. These guardrails may include a maximum retry count, a minimum cooldown period between actions, a maximum computational cost ceiling, and blast radius constraints that limit the scope of infrastructure changes. If the validation process 1112 confirms compliance with these bounds, the system proceeds to execute control action 1114 autonomously, for example by terminating a stalled job and resubmitting it with an updated configuration.

Following the execution of the control action 1114, the platform performs success rate logging 1116. This step maintains an audit trail comprising the diagnosis that triggered the intervention, the guardrail state at the time of execution, the specific action taken, and the measured outcome of the action. This data is leveraged by an update global playbook operator 1118, which refines the decision-making logic of the ML-based diagnosis 1104 over time. Through this feedback loop, the system can distinguish between successful and unsuccessful remediation strategies, thereby increasing the accuracy and reliability of future automated interventions.

FIG. 12 illustrates an example user interface for a job dashboard, according to some aspects of the present disclosure. Dashboard 1200 functions as an observability hub, aggregating and displaying status information for a plurality of jobs 1202a-1202n. Each job card displayed within dashboard 1200 can present real-time telemetry data, such as central processing unit utilization, memory usage, and GPU utilization, alongside status indicators such as healthy, running, or warning states. By providing a consolidated, high-level view of these metrics, dashboard 1200 may allow a user to efficiently monitor the operational health of active jobs and triage potential issues across the container orchestration platform.

FIG. 13 illustrates an example user interface for job detail and artificial intelligence analysis, according to some aspects of the present disclosure. Interface 1300 may be accessed by selecting a specific job from the dashboard 1200 view. In the example user interface of FIG. 13, Job 1210 has been selected. Job detail and artificial intelligence analysis for job 1210 includes graphical charts 1302, which provide visual representations of resource metrics, such as worker memory and worker central processing unit usage, plotted over time. These charts enable a user to visualize operational trends, such as resource utilization stability, performance spikes, or patterns of memory consumption throughout the lifecycle of the job.

Job detail and artificial intelligence analysis for job 1210 further provides functionality for artificial intelligence-powered diagnostics including AI diagnoses 1304, computational resource information 1306 associated with job 1210, and chat interface 1308. A user may interact with a chat interface 1308 to initiate an automated diagnostic process. Upon invocation, the operational intelligence platform can assemble comprehensive context, including job metadata, metrics, logs, and workflow history, to generate a structured diagnosis via the language model (e.g., computational resource information 1306 can be analyzed by one or more computer logic flows described with respect to FIGS. 8-11 to generate AI diagnoses 1304). The resulting diagnostic output, which may include root-cause analysis, severity assessment, and prioritized recommendations, can be presented directly within the user interface.

In one example, a user 802 may interact with the chat interface 1308 to initiate an automated diagnostic process or to perform natural-language queries regarding the status or performance of job 1210. Upon invocation, the operational intelligence platform can assemble comprehensive context, including job metadata, metrics, logs, and workflow history, to generate a structured diagnosis via the language model 816. The resulting diagnostic output, which may include root-cause analysis, severity assessment, and prioritized recommendations, can be presented directly within the user interface, allowing the user to evaluate and act upon the insights generated by the platform's intervention modes, such as the predefined 1108b or automatic 1108c modes described in FIG. 11.

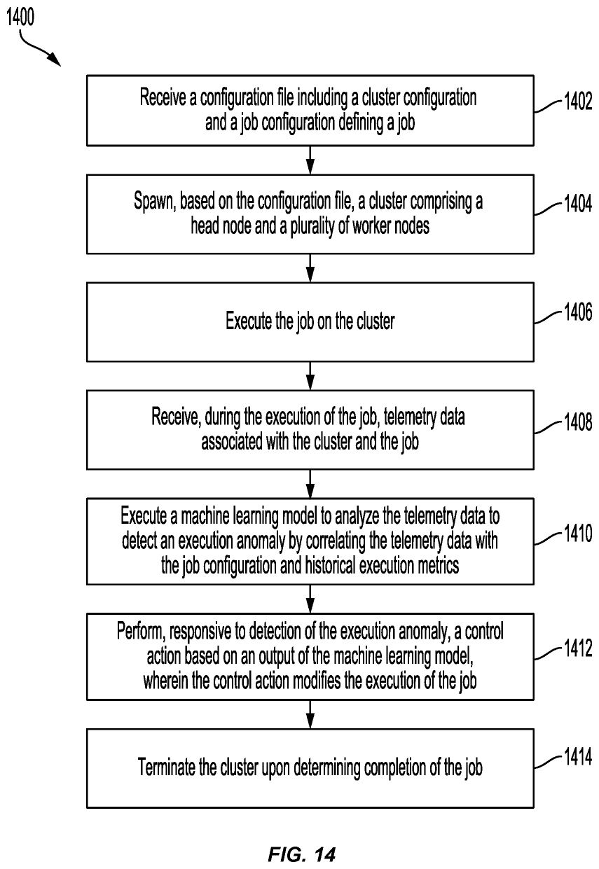

FIG. 14 is an example method 1400 for flexible dynamic autoscaling for distributed computing with integrated operational intelligence, according to some aspects of the present disclosure. The method 1400 will be described with respect to the EKSRay application interface 104 and the operational intelligence platform 810 described with respect to FIGS. 1 and 8. However, in certain examples it may be appreciated that the method 1400 can include one or more additional steps (not shown) such as one or more additional steps described in relation to FIGS. 9-12.

As illustrated in FIG. 14, the method 1400 includes EKSRay application interface 104 receiving a configuration file including a cluster configuration and a job configuration defining a job (1402); spawning, based on the configuration file, a cluster comprising a head node and a plurality of worker nodes (1404); executing the job on the cluster (1406); receiving, during the execution of the job, telemetry data associated with the cluster and the job (1408); executing a machine learning model to analyze the telemetry data to detect an execution anomaly by correlating the telemetry data with the job configuration and historical execution metrics (1410); performing, responsive to detection of the execution anomaly, a control action based on an output of the machine learning model, wherein the control action modifies the execution of the job (1412); and terminating the cluster upon determining completion of the job (1414).

In some examples, executing the job on the cluster (1406) one or more steps described with respect with FIGS. 2B and 2C. In some examples, the cluster configuration defined in the configuration file can include a first node type and a first node option corresponding to the head node; a second node type, a second node option, a minimum number of worker nodes, and a maximum number of worker nodes corresponding to a first worker node of the plurality of worker nodes; and a third node type, a third node option, a minimum number of worker nodes, and a maximum number of worker nodes corresponding to a second worker node of the plurality of worker nodes. In some examples, activating the first worker node can include defining a CPU limit, a memory limit, and a GPU limit, and in some examples, the cluster configuration can include resource tags identifying at least one of the plurality of worker nodes and specifications for the at least one of the plurality of worker nodes.

In some examples, the telemetry data can include at least one of Kubernetes API data, Ray Dashboard metrics, container logs, cloud-based monitoring service metrics, and job metadata.

In some examples, operations executed by the operational intelligence platform 810 can the further include executing a rule-based anomaly detection process to identify the execution anomaly, where the execution anomaly comprises at least one of a memory utilization increase exceeding a threshold, a central processing unit stall, a graphics processing unit stall, or an out-of-memory error event.

In some examples, operations executed by the operational intelligence platform 810 can the further include orchestrating the job as a dynamic directed acyclic graph, wherein the dynamic directed acyclic graph is iteratively modified by the machine learning model based on intermediate execution results of the job.

In some examples, operations executed by the operational intelligence platform 810 can include generating a user interface comprising a chat window configured to receive input from a user, where performing the control action causes a presentation of a result of the control action within the chat window; and causing a presentation of a new configuration file generated by the machine learning model based on the execution anomaly.

In some examples, the job configuration defines a training job for a custom machine learning model configured to analyze vehicle telematics data to detect vehicle crashes or driving behaviors. In these examples, the execution anomaly is identified by the machine learning model based on a target performance analysis of the custom machine learning model, the target performance analysis comprising a determination of whether the custom machine learning model has achieved a threshold level of predictive accuracy.

It should be appreciated that the specific steps illustrated in FIG. 14 provide a particular method for flexible dynamic autoscaling for distributed computing with integrated operational intelligence according to an example of the present disclosure. Other sequences of steps may also be performed according to alternative examples. For example, alternative examples of the present disclosure may perform the steps outlined above in a different order. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize many variations, modifications, and alternatives.

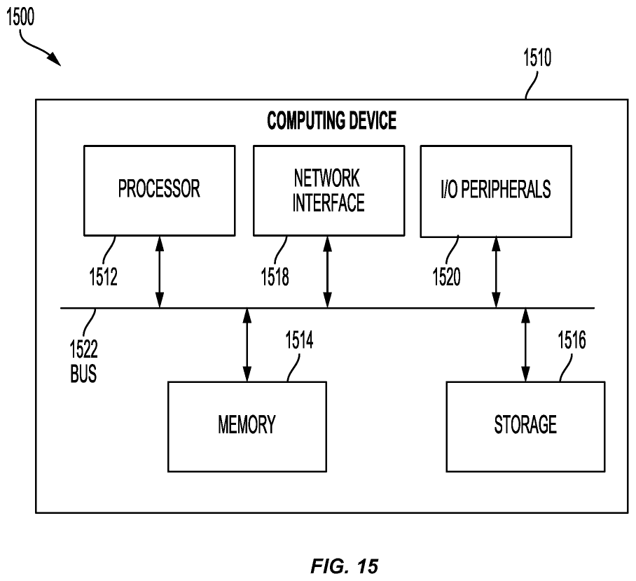

FIG. 15 is a block diagram 1500 of an example computing device 1510 configured to implement examples of one or more aspects of the present disclosure. For example, referring to FIG. 1, the container orchestration platform 110 could be an example of the computing device 1510 described with respect to FIG. 15. Computing device 1510 includes a processor 1512, a memory 1514, a storage device 1516, and one or more input/output peripherals 1520. Each of the components of computing device 1510, including the processor 1512, memory 1514, network interface 1518, I/O peripherals 1520, and storage 1516 can be interconnected, for example, using interface bus 1522.

The processor 1512 is capable of processing instructions for execution within the computing device 1510. The term “execution” as used here refers to a technique in which program code causes a processor to carry out one or more processor instructions. In some implementations, the processor 1512 is a single-threaded processor. In some implementations, the processor 1512 is a multi-threaded processor. The processor 1512 is capable of processing instructions stored in the memory 1514 or on storage 1516. The processor 1512 may execute operations such as those described with reference to FIGS. 1-14.

The memory 1514 stores information within the computing device 1510. In some implementations, memory 1514 is a computer-readable medium. In some implementations, the memory 1514 is a volatile memory unit. In some implementations, the memory 1514 is a non-volatile memory unit.

Storage 1516 may be capable of providing mass storage for the computing device 1510. In some implementations, the storage 1516 is a non-transitory computer-readable medium. In various different implementations, the storage 1516 can include, for example, a hard disk device, an optical disk device, a solid-state drive, a flash drive, magnetic tape, or some other large capacity storage device. In some implementations, the storage 1516 may be a cloud storage device, e.g., a logical storage device including one or more physical storage devices distributed on a network and accessed using a network. In some examples, the storage device may store long-term data.

The I/O peripherals 1520 provide input/output operations for the computing device 1510. In some implementations, the I/O peripherals 1520 can include one or more of a network interface devices, e.g., an Ethernet interface, a serial communication device, e.g., an RS-232 interface, and/or a wireless interface device, a 3G wireless modem, a 4G wireless modem, a 5G wireless modem, etc. In some implementations, the network interface devices may be separate from I/O peripherals 1520 as illustrated in FIG. 15 as network interface 1518. Network interface 1518 allows the computing device 1510 to communicate, for example, transmit and receive data. In some implementations, the I/O peripherals 1520 can include driver devices configured to receive input data and send output data to other input/output devices, e.g., keyboard, printer, and display devices (not shown). In some implementations, mobile computing devices, mobile communication devices, and other devices can be used.

In some examples, the computing device 1510 is contained within a single integrated circuit package. A computing device of this kind, in which both a processor and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the I/O peripherals 1520.

Although an example computing device has been described in FIG. 15, implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. In an example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “computing device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as standalone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

The examples described herein are for illustrative purposes only. Various modifications or changes in light thereof will be apparent to persons skilled in the art. These are to be included within the spirit and purview of this application, and the scope of the appended claims, which follow.

What is claimed is:

1. A system comprising:
at least one processor; and
a memory storing instructions that, when executed by the at least one processor, cause the system to perform operations comprising:
receiving a configuration file including a cluster configuration and a job configuration defining a job;
spawning, based on the configuration file, a cluster comprising a head node and a plurality of worker nodes;
executing the job on the cluster;
receiving, during the execution of the job, telemetry data associated with the cluster and the job;
executing a machine learning model to analyze the telemetry data to detect an execution anomaly by correlating the telemetry data with the job configuration and historical execution metrics;
performing, responsive to detection of the execution anomaly, a control action based on an output of the machine learning model, wherein the control action modifies the execution of the job; and
terminating the cluster upon determining completion of the job.

2. The system of claim, wherein executing the job includes:
activating a first worker node of the plurality of worker nodes to perform a first step of the job;
monitoring a status of the first step of the job;
determining completion of the first step of the job;
responsive to determining completion of the first step of the job, terminating the first worker node of the plurality of worker nodes;
activating a second worker node of the plurality of worker nodes to perform a second step of the job;
monitoring a status of the second step of the job;
determining completion of the second step of the job; and
responsive to determining completion of the second step of the job, terminating the second worker node of the plurality of worker nodes.

3. The system of claim, wherein the cluster configuration comprises:
a first node type and a first node option corresponding to the head node;
a second node type, a second node option, a minimum number of worker nodes, and a maximum number of worker nodes corresponding to a first worker node of the plurality of worker nodes; and
a third node type, a third node option, a minimum number of worker nodes, and a maximum number of worker nodes corresponding to a second worker node of the plurality of worker nodes.

4. The system of claim, wherein activating the first worker node comprises defining a CPU limit, a memory limit, and a GPU limit, and wherein the cluster configuration comprises resource tags identifying at least one of the plurality of worker nodes and specifications for the at least one of the plurality of worker nodes.

5. The system of claim, wherein the telemetry data comprises at least one of Kubernetes API data, Ray Dashboard metrics, container logs, cloud-based monitoring service metrics, and job metadata.

6. The system of claim, wherein the operations further comprise executing a rule-based anomaly detection process to identify the execution anomaly, wherein the execution anomaly comprises at least one of a memory utilization increase exceeding a threshold, a central processing unit stall, a graphics processing unit stall, or an out-of-memory error event.

7. The system of claim, wherein the operations further comprise orchestrating the job as a dynamic directed acyclic graph, wherein the dynamic directed acyclic graph is iteratively modified by the machine learning model based on intermediate execution results of the job.

8. The system of claim, wherein the operations further comprise:
generating a user interface comprising a chat window configured to receive input from a user, wherein performing the control action causes a presentation of a result of the control action within the chat window; and
causing a presentation of a new configuration file generated by the machine learning model based on the execution anomaly.

9. The system of claim 1, wherein the job configuration defines a training job for a custom machine learning model configured to analyze vehicle telematics data to detect vehicle crashes or driving behaviors, and wherein the execution anomaly is identified by the machine learning model based on a target performance analysis of the custom machine learning model, the target performance analysis comprising a determination of whether the custom machine learning model has achieved a threshold level of predictive accuracy.

10. A non-transitory computer-readable medium comprising instructions that, when executed by one or more processors, cause the one or more processors to perform operations comprising:
receiving a configuration file including a cluster configuration and a job configuration defining a job;
spawning, based on the configuration file, a cluster comprising a head node and a plurality of worker nodes;
executing the job on the cluster;
receiving, during the execution of the job, telemetry data associated with the cluster and the job;
executing a machine learning model to analyze the telemetry data to detect an execution anomaly by correlating the telemetry data with the job configuration and historical execution metrics;
performing, responsive to detection of the execution anomaly, a control action based on an output of the machine learning model, wherein the control action modifies the execution of the job; and
terminating the cluster upon determining completion of the job.

11. The non-transitory computer-readable medium of claim, wherein executing the job includes:
activating a first worker node of the plurality of worker nodes to perform a first step of the job;
monitoring a status of the first step of the job;
determining completion of the first step of the job;
responsive to determining completion of the first step of the job, terminating the first worker node of the plurality of worker nodes;
activating a second worker node of the plurality of worker nodes to perform a second step of the job;
monitoring a status of the second step of the job;
determining completion of the second step of the job; and
responsive to determining completion of the second step of the job, terminating the second worker node of the plurality of worker nodes.

12. The non-transitory computer-readable medium of claim, wherein the cluster configuration comprises:
a first node type and a first node option corresponding to the head node;
a second node type, a second node option, a minimum number of worker nodes, and a maximum number of worker nodes corresponding to a first worker node of the plurality of worker nodes; and
a third node type, a third node option, a minimum number of worker nodes, and a maximum number of worker nodes corresponding to a second worker node of the plurality of worker nodes.

13. The non-transitory computer-readable medium of claim, wherein activating the first worker node comprises defining a CPU limit, a memory limit, and a GPU limit, and wherein the cluster configuration comprises resource tags identifying at least one of the plurality of worker nodes and specifications for the at least one of the plurality of worker nodes.

14. The non-transitory computer-readable medium of claim, wherein the job configuration defines a training job for a custom machine learning model configured to analyze vehicle telematics data to detect vehicle crashes or driving behaviors, and wherein the execution anomaly is identified by the machine learning model based on a target performance analysis of the custom machine learning model, the target performance analysis comprising a determination of whether the custom machine learning model has achieved a threshold level of predictive accuracy.

15. The non-transitory computer-readable medium of claim, wherein the operations further comprise orchestrating the job as a dynamic directed acyclic graph, wherein the dynamic directed acyclic graph is iteratively modified by the machine learning model based on intermediate execution results of the job.

16. The non-transitory computer-readable medium of claim, wherein the operations further comprise:
generating a user interface comprising a chat window configured to receive input from a user, wherein performing the control action causes a presentation of a result of the control action within the chat window; and
causing a presentation of a new configuration file generated by the machine learning model based on the execution anomaly.

17. A computer-implemented method comprising:
receiving, by one or more processors, a configuration file including a cluster configuration and a job configuration defining a job;
spawning, by the one or more processors and based on the configuration file, a cluster comprising a head node and a plurality of worker nodes; executing the job on the cluster;
receiving, by the one or more processors during the execution of the job, telemetry data associated with the cluster and the job;
executing, by the one or more processors, a machine learning model to analyze the telemetry data to detect an execution anomaly by correlating the telemetry data with the job configuration and historical execution metrics;
performing, by the one or more processors and responsive to detection of the execution anomaly, a control action based on an output of the machine learning model, wherein the control action modifies the execution of the job; and
terminating, by the one or more processors, the cluster upon determining completion of the job.

18. The computer-implemented method of claim, wherein executing the job includes:
activating a first worker node of the plurality of worker nodes to perform a first step of the job;
monitoring a status of the first step of the job;
determining completion of the first step of the job;
responsive to determining completion of the first step of the job, terminating the first worker node of the plurality of worker nodes;
activating a second worker node of the plurality of worker nodes to perform a second step of the job;
monitoring a status of the second step of the job;
determining completion of the second step of the job; and
responsive to determining completion of the second step of the job, terminating the second worker node of the plurality of worker nodes.

19. The computer-implemented method of claim, wherein the job configuration defines a training job for a custom machine learning model configured to analyze vehicle telematics data to detect vehicle crashes or driving behaviors, and wherein the execution anomaly is identified by the machine learning model based on a target performance analysis of the custom machine learning model, the target performance analysis comprising a determination of whether the custom machine learning model has achieved a threshold level of predictive accuracy.

20. The computer-implemented method of claim, further comprising:
generating a user interface comprising a chat window configured to receive input from a user, wherein performing the control action causes a presentation of a result of the control action within the chat window; and
causing a presentation of a new configuration file generated by the machine learning model based on the execution anomaly.
